(19) United States
(12) Patent Application Publication
(10) Pub. No.: US 2006/0064261 A1
(43) Pub. Date: Mar. 23, 2006

(54) Method for testing a memory using an external test chip, and apparatus for carrying out the method

(75) Inventor: Sven Boldt, Aschheim (DE)

Correspondence Address: Maginot, Moore & Beck;Bank One Tower, Suite 3000, 111 Monument Circle, Indianapolis, IN, 46204-5115, US

(73) Assignee: Infineon Technologies AG, Munchen (DE)

(21) Appl. No.: 11/217,060

(22) Filed: Aug. 31, 2005

(30) Foreign Application Priority Data
Aug. 31, 2004 (DE) 10 2004 042 074.2

(51) Int. Cl. G06F 19/00

(52) U.S. Cl. 702/80

(57) ABSTRACT

The invention provides an electronic memory apparatus having a memory module which is arranged on a first circuit chip and which has at least one memory bank for electronically storing data, and having a test module which has analysis units for testing the memory module. In this arrangement, the memory module is arranged on a first circuit chip. The test module is arranged on a second circuit chip which is provided so as to be physically separate from the memory module arranged on the first circuit chip, with the test module being connected to the memory module via a communication device.

### BACKGROUND

The present invention relates in general to memory apparatuses for electronically storing data, and relates in particular to memory apparatuses which can be tested using test devices which are respectively associated with the memory apparatuses.

Specifically, the present invention relates to an electronic memory apparatus having a memory module which is arranged on a first circuit chip and having a test module. The memory module has at least one memory bank for electronically storing data. The memory bank comprises regularly arranged memory cells.

The test module has analysis units which are designed for testing the memory module. Data can be interchanged between the test module and the memory module of the memory apparatus.

Memory modules (also called memory chips) generally comprise two subunits, the memory array and the control logic with the interface. The memory array is a regular arrangement of memory cells in memory banks, connecting lines and signal amplifiers.

Such a design is used in the same or a similar manner for different memory apparatuses. The control logic and the interface are adapted to meet respective market requirements, with control circuits being able to be designed for a single data rate (SDR) and/or control circuits being able to be designed for a double data rate (DDR). In this context, it is possible for a DDR interface to be completely different from an SDR interface. In addition, different control logic and interface units differ in terms of the number of I/Os required, the demands on the internal test structures and in terms of specially designed power saving circuits.

A substantial portion of the logic circuits which are situated within the memory module's chip are required merely for analysis purposes or for shortening a chip test time. Such logic circuits take up an increasing amount of space as the complexity for testing memory modules which need to be tested increases. Such a space requirement increases the overall chip area per memory apparatus. Such logic circuits are not required in later operation of the memory apparatus and are not used.

FIG. 6 shows a conventional memory apparatus S which is constructed from individual memory banks B1, B2, B3 and B4. A free board region between the memory banks contains arranged analysis units A1, A2, . . . , Aₙ, which form one portion of a test apparatus for testing the memory apparatus S.

As can be seen from FIG. 6, the total chip area increases as a result of the provision of such analysis units. Disadvantageously, the increasing complexity of semiconductor chips, particularly of memory apparatuses, requires ever more complex analysis circuits for testing the memory apparatus. The increasing problem of increased test costs also results in the provision of ever more complex test circuits to reduce the total test time. Another drawback is that many analysis circuits cannot be implemented within the memory apparatus S for reasons of space, which means that test coverage is degraded. It is also inexpedient to pass on the knowledge disclosed by analysis units in a test apparatus in the form of all of the memory apparatuses S.

### SUMMARY

It would therefore be advantageous to provide a memory apparatus in which a chip area is not increased by an associated test apparatus, with high test coverage and low test costs being achieved at the same time.

It would therefore be advantageous to design a memory apparatus comprising a memory module and test module such that the test module is accommodated on a circuit chip which is arranged so as to be separate from the memory module, such that the memory module has exclusively memory functions. For this purpose, the test module is connected to the memory module via a communication device, which can be designed in various advantageous ways.

Such a communication device may be wire-connected or wireless, for example, with a wireless communication link being able to be provided by means of radio (radio frequency) and/or optical data transmission. The inventive apparatus affords the advantage that the provision of a separate chip which has a test module and which has circuits for analysing the memory module and/or for increasing test productivity reduces the overall space requirement of the memory apparatus.

In addition, there is the advantage that analysis circuits, which cannot be accommodated in conventional memory apparatuses for reasons of space, can now be used on the separate circuit chip in order to allow more comprehensive, more effective and/or faster testing of the memory module.

By reducing the total area for a memory apparatus, it is possible to accommodate more memory chips on a wafer than in apparatuses based on the prior art. A test chip which is arranged so as to be physically separate from the memory module can comprise circuits which are more extensive and more suitable for test purposes than in the prior art, since the area requirement of these circuits is no longer restricted by the physical separation of the memory module chip and the test chip. After a memory module which is to be tested has been tested, the test module is easily removed from the memory module, with just the memory module (without test devices) being delivered to an end customer.

This affords the advantage that it avoids the problem of knowledge about the test device being obtained through reengineering, for example when a competitor purchases such memory apparatuses.

In addition, the possibility of non-functioning circuits being arranged on a memory apparatus is reduced, which reduces resultant malfunctions. Another advantage of the inventive apparatus is that a test module can be modified in line with the demands on a test without altering the entire memory apparatus. It is also advantageous that the circuit complexity for the test module can be expanded without needing to alter circuit complexity for the memory module. This allows more extensive and/or more accurate test analyses.

In accordance with one general aspect, the inventive electronic memory apparatus comprises:
a) a memory module which is arranged on a first circuit chip and which has at least one memory bank for electronically storing data; and
b) a test module which has analysis units for testing the memory module or the memory banks contained in the memory module,
c) with the test module being arranged on a second circuit chip which is provided so as to be physically separate from the memory module arranged on the circuit chip, and
d) the test module being connected to the memory module via a communication device.

In addition, the inventive method for storing data has the following steps:
a) a memory module which is arranged on a first circuit chip and which has at least one memory bank is provided;
b) data are stored in the at least one memory bank of the memory module; and
c) the memory module is tested in order to check the operability of the memory module using a test module which has analysis units suitable for testing the memory module, with
d) the test module being arranged on a second circuit chip which is provided so as to be physically separate from the memory module arranged on the first circuit chip, and
e) the test module being connected to the memory module using a communication device.

In accordance with one preferred development of the present invention, the memory module has a contact-making region in which contact-making elements for making contact with the at least one memory bank of the memory module are provided. Preferably, the test module has a connection region in which connection elements for connecting the analysis units of the test module are provided.

In accordance with a further preferred development of the present invention, the communication device has communication links for electrically connecting the contact-making elements of the memory module to the connection elements of the test module.

In accordance with yet another preferred development of the present invention, the memory module has at least one memory module transmission/reception device, with the test module preferably having at least one test module transmission/reception device and the communication device between the memory module and the test module being designed to be a radio link.

In accordance with yet another preferred development of the present invention, the memory module has at least one optical memory module transmission/reception device, and the test module has at least one optical test module transmission/reception device, such that the communication device between the memory module and the test module provides an optical link.

Preferably, the communication device provides the optical link between the memory module and the test module in the infrared spectral range.

In accordance with yet another preferred development of the present invention, the communication device for providing the optical link between the memory module and the test module is designed to be an optical waveguide link.

In accordance with yet another preferred development of the present invention, the contact-making elements provided in the contact-making region of the memory module and/or the connection elements provided in the connection region of the test module are respectively in the form of a needle card device.

In accordance with yet another preferred development of the present invention, the contact-making elements provided in the contact-making region of the memory module and/or the connection elements provided in the connection region of the test module are respectively designed to be a ball grid array (BGA).

It is also advantageous for the communication device for making electrical contact between the contact-making elements of the memory module and the connection elements of the test module to be in the form of a flip-chip board.

Preferably, the communication device has connection units for connecting external control units and/or external power supply units.

In accordance with yet another preferred development of the present invention, at least two memory modules are connected to a test module using the communication device.

This means that the inventive electronic memory apparatus allows memory modules to be designed in extremely space-saving fashion, with improved test coverage and reduced test times being obtained at the same time. This advantageously results firstly in more reliable operation of the memory modules and secondly in reduced test costs.

### BRIEF DESCRIPTION OF THE DRAWINGS

Exemplary embodiments of the invention are illustrated in the drawings and are explained in more detail in the description below.

In the drawings:

FIG. 1 shows a memory module formed from regularly arranged memory banks to illustrate the basic principles of the invention;

FIG. 2 shows a memory module which comprises four memory banks and has a contact-making region, in which contact-making elements are arranged, in line with a preferred exemplary embodiment of the present invention;

FIG. 3 shows a test module having a defined connection region in which connection elements are accommodated, the test module also having analysis units for carrying out tests for the memory module, in line with a preferred exemplary embodiment of the present invention;

FIG. 4 shows an example of a link between the memory module shown in FIG. 2 and the test module shown in FIG. 3 via a communication device;

FIG. 5 shows a wireless link between the memory module shown in FIG. 2 and the test module shown in FIG. 3 using memory module transmission/reception devices and test module transmission/reception devices, in line with a preferred exemplary embodiment of the present invention; and

FIG. 6 shows an electronic memory apparatus based on the prior art.

In the figures, identical reference symbols denote components or steps which are the same or have the same function.

### DESCRIPTION

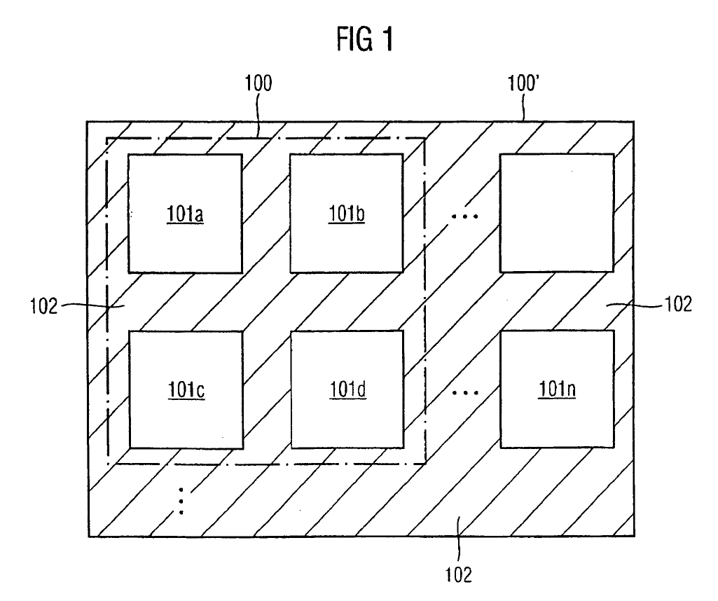

FIG. 1 shows a memory module 100′ which comprises regularly arranged memory banks 101a-101n. In addition, FIG. 1 shows a free board region 102 of the memory module 100′, in which normally analysis circuits for a test device or portions of analysis circuits from test devices are accommodated. The inventive electronic memory apparatus allows a reduction in a total area by the amount which is otherwise required for such analysis circuits by virtue of the analysis circuits being arranged so as to be completely physically separate from the memory module 100′ (see description below with reference to FIG. 3).

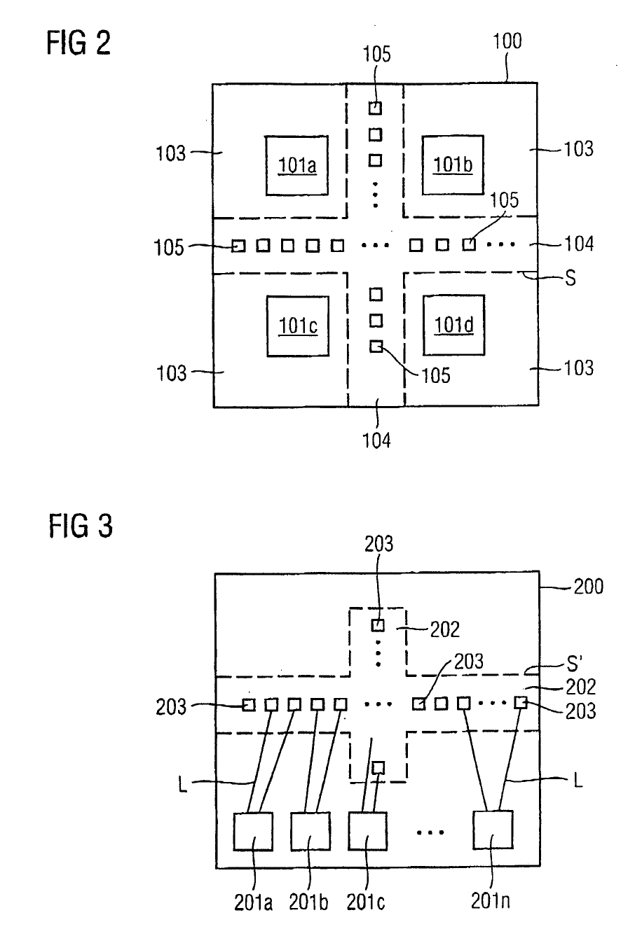

The text below explains a memory module 100 comprising four memory banks 101a, 101b, 101c and 101d with reference to FIG. 2.

As FIG. 2 shows, the memory module 100 comprising four memory banks 101a-101d has a memory bank region 103 and a contact-making region 104. The contact-making region 104 is a small portion of the free board area provided in a conventional memory area. As a result of a compact arrangement for the contact-making region between the memory banks 101a-101d (region between the dashed lines S in FIG. 2), it is possible to provide the memory banks 101a-101d with more space. On the other hand, if the size of the memory banks 101a-101d remains the same, the total chip area required for the memory module 100 can be reduced.

The contact-making region 104 may firstly contain contact-making elements 105, as illustrated in FIG. 2, or else memory module transmission/reception devices 106, as illustrated below with reference to FIG. 5.

The text below describes the making of electrical contact between the memory module 100 and the test module 200, so that the contact-making region 104 contains contact-making elements 105 (small squares in FIG. 2).

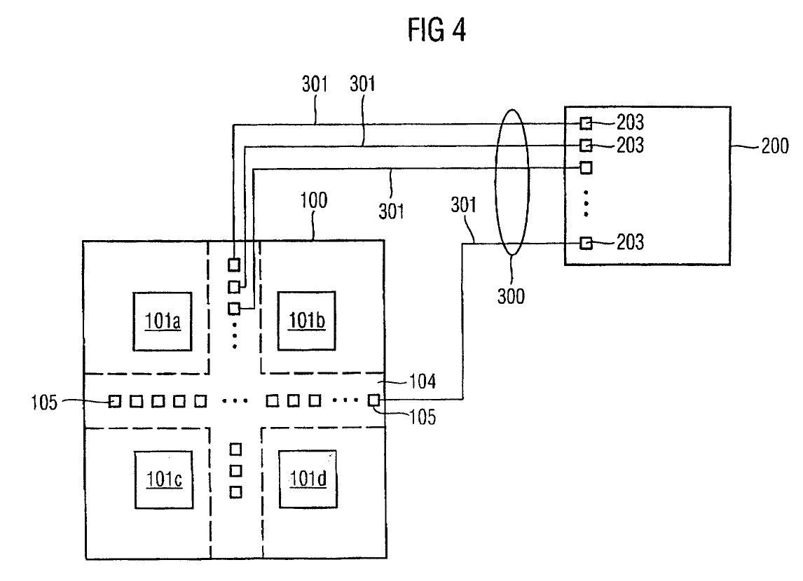

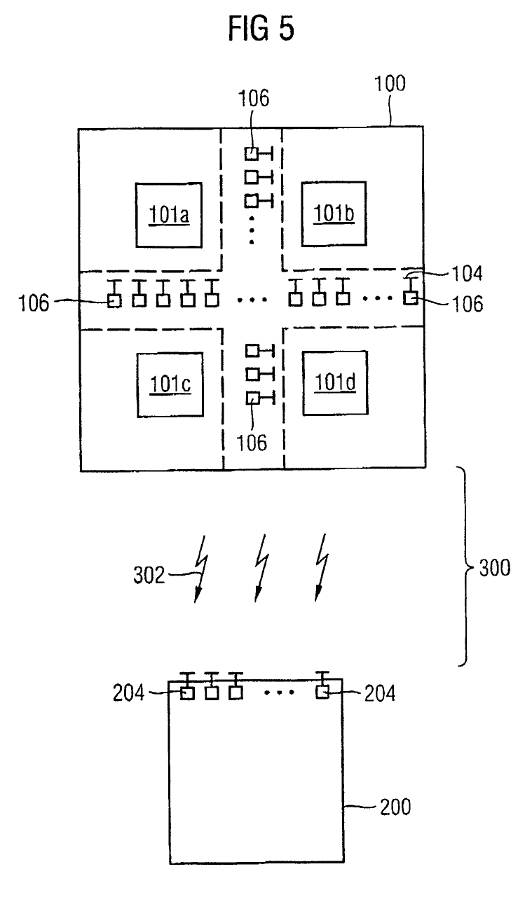

In this case, the arrangement of the contact-making elements 105 in the contact-making region 104 is arbitrary and needs only to satisfy the demand that the communication device 300 (described below with reference to FIG. 4) can be connected in order to connect the test module 200 (FIG. 3, FIG. 4) to the memory module.

As FIG. 3 illustrates, the arrangement of the contact-making elements 105 of the memory module 100 is designed in line with an arrangement of connection elements 203 of the test module 200. FIG. 2 shows the test module 200 based on a preferred exemplary embodiment of the present invention. A connection region 202 of the test module 200 (region within the dashed line S′) contains the connection elements 203 in an arrangement whose geometry corresponds to the contact-making elements 105 of the memory module 100. The connection elements 203 are connected to analysis units 201a-201n arranged on the test module 200 (indicated by lines L in FIG. 3).

The analysis units 201a-201n (also called analysis circuits) are used to provide suitable tests for testing the memory module 100. In line with the invention, the test module 200 is accommodated on a second circuit board which is physically separate from the first circuit board, on which the memory module 100 is arranged. In addition, a link between the memory module 100 and the test module 200 based on a preferred embodiment of the present invention is illustrated. For this purpose, a communication device 300 comprises communication links 301, which are designed to be electrical conducting wires, for example. In this context, appropriate contact-making elements 105, which are present in the contact-making region 104 of the memory module 100, are electrically connected to associated connection elements 203, which are present in the connection region 202 of the test module.

In this way, communication or data interchange takes place between the memory module 100 and the test module 200 when the memory module 100 is tested. Preferably, although FIG. 4 does not illustrate this, the communication device 300 can be provided as a needle card device. In this case, the needle card device makes contact firstly with the contact-making elements 105 provided in the contact-making region 104 of the memory module 100 and secondly with the connection elements 204 provided in the connection region 202 of the test module 200. In addition, it is possible for the contact-making elements 105 provided in the contact-making region 104 of the memory module 100 and/or for the connection elements 203 provided in the connection region 202 of the test module 200 themselves to be designed to be such a needle card device for making electrical contact.

Furthermore, the communication device 300 for electrically connecting the memory module 100 to the test module 200 may be designed to be a flip-chip board in order to achieve flexible connection between the memory module 100 and the test module 200. The communication device 300 preferably has additional connection units for connecting external control units and/or external power supply units.

FIG. 5 shows a further preferred exemplary embodiment of a communication device 300. In this case, a wireless communication link, i.e. a radio link 302, is provided between the memory module 100 and the test module 200. For this purpose, the contact-making elements 105 of the memory module 100 which are shown in FIG. 2 have been replaced with memory module transmission/reception devices 106, which are arranged in the contact-making region 104.

In addition, the connection elements 203 in the connection region 202 of the test module 200 which were mentioned with reference to FIG. 3 have been replaced with corresponding test module transmission/reception devices 204 on the test module 200. There is therefore the advantage that extensive tests using complex test modules 200 can be performed on memory modules 100 which are to be tested without needing to provide a wire-connected link between the memory module and the test module.

The design of transmission/reception devices which can be used on the memory module 100 (memory module transmission/reception devices 106) and of transmission/reception devices which can be used on the test module 200 (test module transmission/reception devices 204) is one with which the person skilled in the art is familiar, so that a description of such transmission/reception devices is omitted here.

It should be pointed out that when the distance to be spanned between the test module 200 and the memory module 100 is short it is necessary to provide only low transmission powers in the corresponding transmission/reception devices 106, 204, which means that the result is a small physical size for the transmission/reception devices, particularly for the memory module transmission/reception devices 106.

This maintains the advantage of the present invention, i.e. a reduction in the chip area of the memory module 100 is ensured.

Particularly in the case of the exemplary embodiment shown in FIG. 5, it is possible for more than one memory module 100 to communicate with the test module 200 via the communication device 300. This means that it is possible to use test modules 200 of complex design which address memory modules 100 in succession or simultaneously in order to test them.

A further preferred exemplary embodiment of the present invention provides an optical link between the memory module 100 and the test module 200. For this purpose, the memory module 100 has at least one optical memory module transmission/reception device, while the test module has at least one optical test module transmission/reception device. Preferably, such an optical communication device provides an optical link between the memory module 100 and the test module 200 in the infrared spectral range.

Another possibility, although not shown in FIG. 5, is for the communication device 300 for providing the optical link between the memory module 100 and the test module 200 to be designed to be an optical waveguide link. In contrast to the electrical link illustrated with reference to FIG. 4, such an optical waveguide link has the advantage that communication between the memory module 100 and the test module 200 cannot be obstructed by electrical and/or magnetic interference fields.

The inventive electronic memory apparatus and the inventive method attain the advantage that a memory module to be tested can be tested ever more effectively even as developments continue from chip generation to chip generation. In this case, the test module can be adapted to suit the increasing complexity during testing without increasing the chip area of the memory modules which are to be tested.

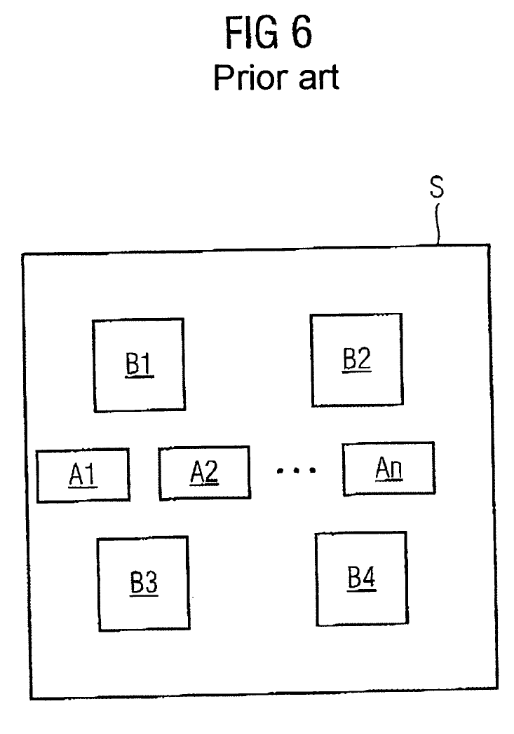

With regard to the conventional electronic memory apparatus shown in FIG. 6, reference is made to the introduction to the description.

Although the present invention has been described above with reference to preferred exemplary embodiments, it is not limited thereto but rather can be modified in a wide variety of ways.

The invention is also not limited to the cited application options.

1-16. (canceled)

17. An electronic memory apparatus comprising:
a) a memory module arranged on a first circuit chip, the memory module including at least one memory bank configured to electronically store data; and
b) a test module connected to the memory module via a communication device, wherein the test module is arranged on a second circuit chip with the second circuit chip physically separate from the memory module arranged on the first circuit chip, the test module including analysis units configured to test the memory module.

18. The electronic memory apparatus of claim 17 wherein the memory module includes a contact-making region and wherein contact-making elements configured to make contact with the at least one memory bank of the memory module are provided in the contact-making region.

19. The electronic memory apparatus of claim 17 wherein the test module includes a connection region and wherein connection elements configured to connect the analysis units of the test module are provided in the connection region.

20. The electronic memory apparatus of claim 19 wherein the communication device includes communication links configured to electrically connect the contact-making elements of the memory module to the connection elements of the test module.

21. The electronic memory apparatus of claim 17 wherein the memory module includes has at least one memory module transmission/reception device, wherein the test module includes at least one test module transmission/reception device, and wherein the communication device is operable to provide a radio link between the memory module and the test module.

22. The electronic memory apparatus of claim 17 wherein the memory module includes at least one optical memory module transmission/reception device, wherein the test module includes at least one optical test module transmission/reception device, and wherein the communication device is operable to provide an optical link between the memory module and the test module.

23. The electronic memory apparatus of claim 22 wherein the communication device provides the optical link between the memory module and the test module in the infrared spectral range.

24. The electronic memory apparatus of claim 22 wherein the communication device operable to provide the optical link between the memory module and the test module is configured as an optical waveguide link.

25. The electronic memory apparatus of claim 18 wherein the contact-making elements provided in the contact-making region of the memory module are in the form of a needle card device.

26. The electronic memory apparatus of claim 19 wherein the connection elements provided in the connection region of the test module are in the form of a needle card device.

27. The electronic memory apparatus of claim 18 wherein the contact-making elements provided in the contact-making region of the memory module are configured as a ball grid array (BGA).

28. The electronic memory apparatus of claim 19 wherein the connection elements provided in the connection region of the test module are configured as a ball grid array (BGA).

29. The electronic memory apparatus of claim 19 wherein the communication device is configured to make electrical contact between the contact-making elements of the memory module and the connection elements of the test module, and wherein the communication device is in the form of a flip-chip board.

30. The electronic memory apparatus of claim 17 wherein the communication device includes connection units configured to connect external control units.

31. The electronic memory apparatus of claim 17 wherein the communication device includes connection units configured to connect power supply units.

32. A method for storing data, the method comprising:
a) providing a memory module arranged on a first circuit chip, the memory module including at least one memory bank;
b) storing data in the at least one memory bank of the memory module;
c) providing a test module arranged on a second circuit chip, the test module including analysis units configured for testing the memory module, wherein the second circuit chip is provided physically separate from the memory module arranged on the first circuit chip, and wherein the test module is in communication with the memory module by a communication device; and
d) testing the memory module with the test module in order to check the operability of the memory module.

33. The method of claim 32 wherein the communication device provides a radio link between the memory module and the test module using at least one memory module transmission/reception device provided in the memory module and using at least one test module transmission/reception device provided in the test module.

34. The method according to claim 32 wherein the communication device provides an optical link between the memory module and the test module using at least one optical memory module transmission/reception device provided in the memory module and using at least one optical test module transmission/reception device provided in the test module.

35. The method of claim 32 wherein at least two memory modules are connected to a test module using the communication device.

36. An electronic memory apparatus comprising:
a) means for storing data, said means for storing data provided on a first circuit chip;
b) means for testing the means for storing data in order to check the operability of the means for storing data, wherein the means for testing is provided on a second circuit chip, wherein the second circuit chip is physically separate from the means for storing data provided on the first circuit chip; and
c) means for providing communication between the means for storing data and the means for testing data.
